(19) United States
(12) Patent Application Publication
(10) Pub. No.: US 2007/0225934 A1
(43) Pub. Date: Sep. 27, 2007

(54) Measuring apparatus

(75) Inventors: Masahiko Moriya, Tokyo (JP); Yuichiro Takahashi, Tokyo (JP); Toru Shimura, Tokyo (JP); Naoki Maeda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 11/725,448

(22) Filed: Mar. 20, 2007

(30) Foreign Application Priority Data
Mar. 24, 2006 (JP) 2006-082472

(51) Int. Cl. G06F 19/00; G01L 15/00

(52) U.S. Cl. 702/138; 702/189; 702/1; 702/127

(57) ABSTRACT

A measuring apparatus includes a sensor unit, a processing unit, and a communication unit. The sensor unit may include at least one sensor that is configured to generate an output signal. The processing unit may be configured to be separate from the sensor unit. The processing unit may be configured to perform at least a first set of operations based on the output signal. The communication unit may couple the sensor unit and the processing unit. The communication unit may be configured to transmit the output signal as a digital signal from the sensor unit to the processing unit.

### BACKGROUND OF THE INVENTION

1. Field of the Invention

The present invention generally relates to a measuring apparatus. More specifically, the present invention relates to a measuring apparatus for performing a predetermined operation based on an output signal from a sensor.

Priority is claimed on Japanese Patent Application No. 2006-82472, filed Mar. 24, 2006, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

A variety of measuring apparatuses have been known, which are configured to perform a predetermined operation based on an output signal from a sensor. A typical example of the measuring apparatuses may be a pressure measuring apparatus. In a typical case, the pressure measuring apparatus may be configured so that a processing unit such as a CPU (Central Processing Unit) performs a predetermined set of operations based on an output signal or signals that are supplied from a pressure sensor or sensors. The pressure sensor is configured to receive and detect pressure.

In general, it is necessary to maintain the processing unit of the measuring apparatus. Namely, the processing unit needs to be checked, repaired or replaced. The measuring apparatus is in general placed adjacent to a measuring target, of which the physical quantity needs to be measured by the measuring apparatus. In many cases, the processing unit is positioned so that the operability thereof is poor. For example, the pressure measuring apparatus may often be provided to equipment such as a pipe that is placed in a narrow or closed space. The narrow or closed space can provide poor operability to the processing unit that is integrated in the measuring apparatus.

In some cases, plural measuring apparatuses are placed at different positions. A maintainer needs to move among the different positions to maintain each processing unit that is integrated in each of the plural measuring apparatuses. This increases the necessary time to complete the necessary maintenance.

In some cases, the measuring apparatus may integrate a display unit that is configured to display the result of calculation and the state of a sensor or sensors. The measuring apparatus may often be placed at a position that provides poor visibility to the display unit. Namely, the position makes it inconvenient for a maintainer to view the display. This may increase the necessary time to view the display units of all the measuring apparatuses.

It may be assumed that the measuring apparatus is configured so that the processing unit is separated from the senor unit, provided that the sensor unit is provided adjacent to a measuring target, while the processing unit is provided at a convenient position that provides high operability and/or visibility. This configuration needs a communication cable that connects the processing unit and the senor unit. The senor is in general configured to generate an analog output signal. This analog signal is then transmitted through the communication cable to the processing unit. However, the transmission of the analog signal through the communication cable can also provide noise to the analog output signal. More specifically, the transmitted analog output signal can include any noise. The noise-included analog signal may decrease the reliability of the detected results.

It is also assumed that impulse lines are used to connect a measuring target to a pressure measuring apparatus that is, however, placed at a convenient position that provides high operability and visibility. The use of impulse lines may cause the following problems. The impulse lines may be deformed by external factors such as temperature variation. The deformation of the impulse lines may decrease the reliability of the detected results. The density of a fluid flowing in the impulse lines may vary due to external factors such as temperature variation. The variation in the density of the fluid may also decrease the reliability of the detected results. Provision of the impulse lines increases the cost for the pressure measuring apparatus.

In view of the above, it will be apparent to those skilled in the art from this disclosure that there exists a need for an improved apparatus and/or method. This invention addresses this need in the art as well as other needs, which will become apparent to those skilled in the art from this disclosure.

### SUMMARY OF THE INVENTION

Accordingly, it is a primary object of the present invention to provide a measuring apparatus.

It is another object of the present invention to provide a measuring apparatus with improved reliability.

It is a further object of the present invention to provide a measuring apparatus with improved operability.

It is a still further object of the present invention to provide a measuring apparatus with improved visibility.

In accordance with a first aspect of the present invention, a measuring apparatus may include, but is not limited to, a sensor unit, a processing unit, and a communication unit. The sensor unit may include at least one sensor that is configured to generate an output signal. The processing unit may be configured to be separate from the sensor unit. The processing unit may be configured to perform at least a first set of operations based on the output signal. The communication unit may couple the sensor unit and the processing unit. The communication unit may be configured to transmit the output signal as a digital signal from the sensor unit to the processing unit.

The transmission of the output digital signal from the sensor unit to the processing unit through the communication unit can ensure that the transmitted output signal is free of any substantial noise or have substantially reduced noise. The above-described configuration of the measuring apparatus may permit a noise-free or noise-reduced output signal to be transmitted from the sensor unit to the processing unit. This configuration may allow the sensor unit and the processing unit to be separate from each other but to be coupled through the communication unit such as a communication cable. Thus, the sensor unit may be placed adjacent to a measuring target, while the processing unit may be placed at a different or distanced position that may provide high operability and/or visibility. Thus, the above-described measuring apparatus may improve reliability, operability and/or visibility.

In some cases, the processing unit may further include a processor and a display. The processor is configured to perform the operation based on the output signal and generate a first set of information. The display is configured to receive the first set of information from the processor and display the first set of information.

In some cases, the sensor unit may include at least a storage unit that is configured to store the characteristics of at least the sensor. The communication unit is configured to transmit the characteristics of at least the sensor to the processing unit.

In some cases, the sensor unit may include an auxiliary processor that is configured to perform a second set of operations.

In some cases, the processor may be configured to perform a second set of operations in addition to the first set of operations.

In some cases, the communication unit may further include, but is not limited to, first and second communication processors, and a communication cable. The first communication processor may be functionally coupled to the sensor unit. The second communication processor may be functionally coupled to the processor unit. The communication cable may connect the first and second communication processors to each other. The first communication processor and the sensor unit may be enclosed in a first enclosure, while the second communication processor and the processor unit may be enclosed in a second enclosure.

In some cases, the communication unit is configured to transmit the output signal as a serial digital signal.

In some cases, the processing unit may include, but is not limited to, at least an additional sensor.

These and other objects, features, aspects, and advantages of the present invention will become apparent to those skilled in the art from the following detailed descriptions taken in conjunction with the accompanying drawings, illustrating the embodiments of the present invention.

### BRIEF DESCRIPTION OF THE DRAWINGS

Referring now to the attached drawings which form a part of this original disclosure:

FIG. 1 is a schematic perspective view illustrating a pressure measuring apparatus in accordance with a first embodiment of the present invention;

FIG. 2 is a block diagram illustrating the functional configurations of the pressure measuring apparatus shown in FIG. 1;

FIG. 3 is a block diagram illustrating the functional configurations of a modified pressure measuring apparatus in accordance with a second embodiment of the present invention;

FIG. 4 is a schematic perspective view illustrating a pressure measuring apparatus in accordance with a third embodiment of the present invention; and

FIG. 5 is a block diagram illustrating the functional configurations of the pressure measuring apparatus shown in FIG. 4.

### DETAILED DESCRIPTION OF THE INVENTION

Selected embodiments of the present invention will now be described with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

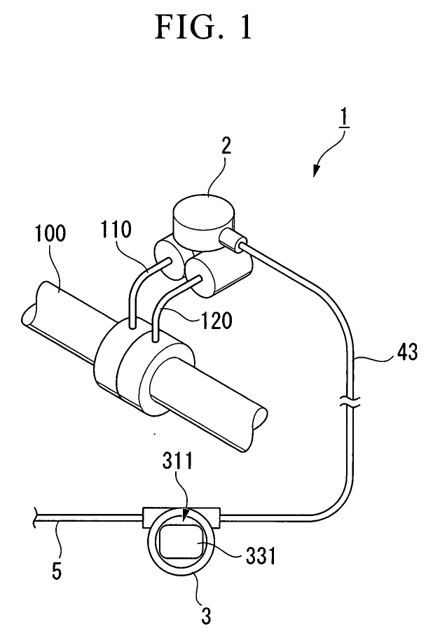

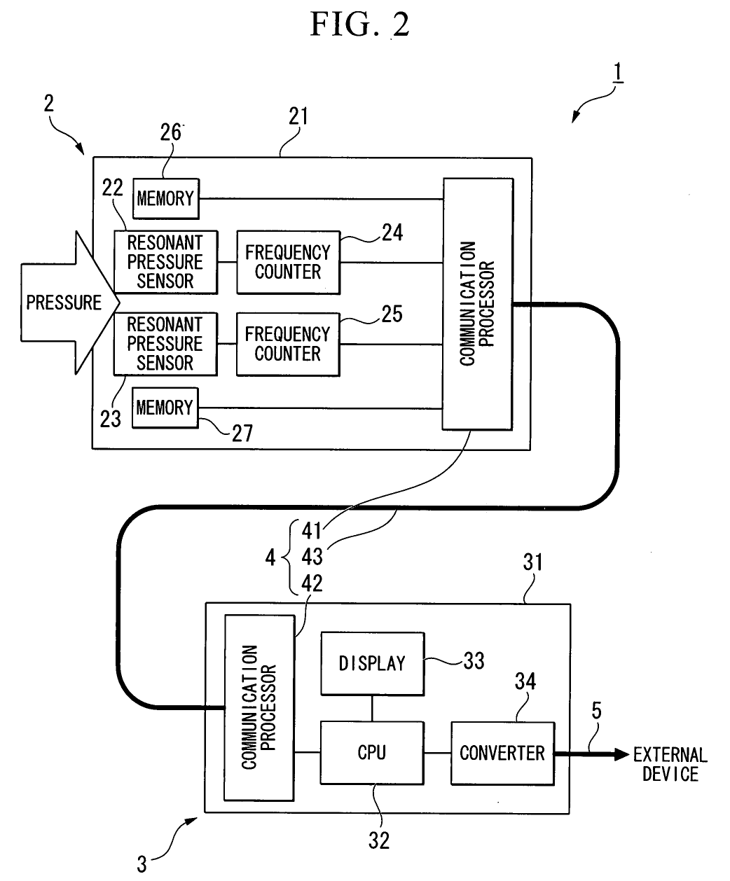

FIG. 1 is a schematic perspective view illustrating a pressure measuring apparatus in accordance with a first embodiment of the present invention. FIG. 2 is a block diagram illustrating the functional configurations of the pressure measuring apparatus shown in FIG. 1.

A pressure measuring apparatus 1 may be configured to measure a differential pressure between first and second pressures of a fluid. The first and second pressures of a fluid travel from a pipe 100 through first and second impulse lines 110 and 120, respectively. The pipe 100 has an orifice plate that is not illustrated in FIG. 1. The pressure measuring apparatus 1 may be configured to be communicated through the first and second impulse lines 110 and 120 to upstream and downstream portions of the pipe 100. The upstream and downstream portions of the pipe 100 are positioned upstream and downstream of the orifice plate. As shown in FIG. 2, the pressure measuring apparatus I may include, but is not limited to, a sensor unit 2, a processing unit 3, and a communication unit 4.

The sensor unit 2 may include, but is not limited to, a first enclosure 21, first and second resonant pressure sensors 22 and 23, first and second frequency counters 24 and 25, and first and second memories 26 and 27. The first enclosure 21 is coupled with the first and second impulse lines 110 and 120.

The first enclosure 21 may be configured to enclose the first and second resonant pressure sensors 22 and 23, the first and second frequency counters 24 and 25, and the first and second memories 26 and 27 as well as a first communication processor 41 as a part of the communication unit 4. The shape of the first enclosure 21 may be optional, but typically may be cylindrical in general.

The first and second resonant pressure sensors 22 and 23 may be configured to be coupled with the first and second impulse lines 110 and 120, respectively. The first and second resonant pressure sensors 22 and 23 may be configured to receive and detect the first and second pressures of a fluid that have traveled from the upstream and downstream portions of the pipe 100. The first and second resonant pressure sensors 22 and 23 may be configured to generate first and second analog signals that have first and second frequencies, respectively. The first and second frequencies depend on the detected first and second pressures of a fluid. Namely, the first and second frequencies indicate the detected first and second pressures of a fluid. For example, the first and second resonant pressure sensors may be realized by, but are not limited to, a silicon resonant pressure sensor. The silicon resonant pressure sensor has a diaphragm and a silicon resonator that is provided on the diaphragm. The silicon resonator has a natural frequency that varies depending upon the pressure applied to the diaphragm.

The first and second frequency counters 24 and 25 may be configured to be electrically connected to the first and second resonant pressure sensors 22 and 23 so as to receive the first and second analog signals with the first and second frequencies from the first and second resonant pressure sensors 22 and 23, respectively. The first and second frequency counters 24 and 25 may be configured to count the first and second frequencies of the first and second analog signals, respectively. The first and second frequency counters 24 and 25 may be configured to generate first and second parallel signals as digital signals, respectively. The first and second parallel signals indicate first and second counted values that correspond to the first and second frequencies, respectively. In some cases, the first and second frequency counters 24 and 25 may be configured to output the first and second parallel signals that include the first and second counted values, respectively.

The first and second memories 26 and 27 may be configured to store the characteristics of the first and second resonant pressure sensors 22 and 23, respectively. For example, the first and second memories 26 and 27 may be realized by, but are not limited to, a non-volatile memory such as EEP-ROM. Typical examples of the characteristics of the first and second resonant pressure sensors 22 and 23 may include, but are not limited to variations of the first and second frequencies of the first and second analog signals that are output from the first and second resonant pressure sensors 22 and 23. The variations of the first and second frequencies may be caused by the external temperature and the characteristics of the diaphragm.

The processing unit 3 may be configured to be separate from the sensor unit 2. The processing unit 3 may be configured to be spatially separate from but functionally coupled to the sensor unit 2. The processing unit 3 may be placed at a convenient position in view of operability and visibility. The processing unit 3 may include, but is not limited to, a second enclosure 31, a CPU 32, a display 33, and a converter 34. The second enclosure 31 may be configured to enclose the CPU 32, the display 33, and the converter 34 as well as a second communication processor 42 as a part of the communication unit 4. As shown in FIG. 1, the display 33 has a screen 331. The second enclosure 31 has an opening 311 that allows the screen 331 to be shown.

The CPU 32 may be configured to perform a predetermined operation based on a parallel signal that is given from the outside. In some cases, the CPU 32 may be configured to calculate the differential pressure between the first and second pressures of a fluid of the first and second impulse lines 110 and 120, respectively. The CPU 32 may also be configured to supply the calculated value of the differential pressure to the display 33 and the converter 34. In addition, the CPU 32 may be configured to set a measuring span and perform a function of scaling in accordance with instructions from an operator or an external device placed outside of the present apparatus.

The display 33 may be functionally coupled to the CPU 32. The display 33 may be configured to display in accordance with input signals that are supplied from the CPU 32. For example, the display 33 may be configured to receive the calculated value of the differential pressure from the CPU 32 and display the measured differential pressure. For example, the display 33 may be realized by, but is not limited to, a known display such as a liquid crystal display or a pointer.

The converter 34 may be electrically coupled to the CPU 32. The converter 34 may also be electrically coupled to a wiring 5 which is connected to an external device that is not illustrated. The converter 34 may be configured to receive an output signal from the CPU 32 and convert the output signal into a converted signal that is adaptable to the external device. The converter 34 may be configured to supply the converted signal through the wiring 5 to the external device.

The converter 34 may also be configured to receive an input signal that is supplied through the wiring 5 from the external device and to convert the input signal into a parallel signal that is adaptable to the CPU 32.

The communication unit 4 may include, but is not limited to, the first and second communication processors 41 and 42, and a cable 43 that connects the first and second communication processors 41 and 42 to each other.

The first communication processor 41 may be contained in the first enclosure 21 of the sensor unit 2. The first communication processor 41 may be electrically connected to the first and second memories 26 and 27 and the first and second frequency counters 24 and 25. The first communication processor 41 may be configured to receive the first and second parallel signals from the first and second frequency counters 24 and 25. The first and second digital signals indicate first and second counted values. The first communication processor 41 may be configured to convert the first and second counted values into a serial signal in accordance with a predetermined standard, for example, “Recommended Standard-485C”. The serial signal is a digital signal. The first communication processor 41 may be configured to transmit the serial signal through the cable 43 to the second communication processor 42.

The second communication processor 42 may be contained in the second enclosure 31 of the processing unit 3. The second communication processor 42 may be connected to the cable 43. The second communication processor 42 may also be electrically connected to the CPU 32. The second communication processor 42 may be configured to receive the serial signal from the first communication processor 41. The second communication processor 42 may be configured to convert the serial signal into first and second parallel signals. The second communication processor 42 may be configured to supply the first and second parallel signals to the CPU 32.

The pressure measuring apparatus 1 may be configured that the sensor unit 2 and the processing unit 3 are separate from each other and are functionally or electrically coupled to each other through the communication unit 4.

The CPU 32 may be electrically coupled to the external device through the converter 34 and the wiring 5 so as to allow an operator to operate the external device, thereby giving the CPU 32 the instructions. The pressure measuring apparatus 1 may be configured to allow an operator to operate the external device so as to change the contents to be displayed on the screen 331 of the display 33, change the measuring span, and scale the calculation result.

Operations of the pressure measuring apparatus 1 will be described.

As described above, the upstream and downstream portions of the pipe 100 are respectively positioned upstream and downstream of the orifice. The upstream and downstream portions of the pipe 100 have first and second pressures of a fluid, respectively. The flow of a fluid through the orifice may in general cause the first and second pressures to be different from each other. The first and second impulse lines 110 and 120 connect or communicate the upstream and downstream portions of the pipe 100 to the first and second resonant pressure sensors 22 and 23, respectively. The first and second pressures of a fluid travel through the first and second impulse lines 110 and 120 to the first and second resonant pressure sensors 22 and 23, respectively.

The first and second resonant pressure sensors 22 and 23 receive the first and second pressures of a fluid and generate first and second analog signals that have first and second frequencies, respectively. The first and second frequencies depend upon the first and second pressures of a fluid, respectively. Namely, the first and second frequencies indicate the first and second pressures of a fluid. The first and second analog signals are transmitted from the first and second resonant pressure sensors 22 and 23 to the first and second frequency counters 24 and 25, respectively.

The first and second frequency counters 24 and 25 count the first and second frequencies of the first and second analog signals, respectively. The first and second frequency counters 24 and 25 generate first and second parallel signals that include the first and second counted values of the first and second frequencies, respectively. The first and second parallel signals are transmitted from the first and second frequency counters 24 and 25 to the first communication processor 41.

The first communication processor 41 converts the first and second parallel signals into a serial signal in accordance with the predetermined standard or regulation. The serial signal may be in the form of a digital signal package. The serial signal includes the first and second counted values of the first and second frequencies as having been converted from the first and second parallel signals that include the first and second counted values of the first and second frequencies.

The serial signal including the first and second counted values is transmitted from the first communication processor 41 through the cable 43 to the second communication processor 42. The second communication processor 42 converts the serial signal into parallel signals that are adaptable to the CPU 32. The parallel signals include the first and second counted values of the first and second frequencies as having been converted from the serial signal including the first and second counted values. The parallel signals are transmitted from the first communication processor 41 to the CPU 32.

The CPU 32 receives the parallel signals including the first and second counted values from the second communication processor 42. The CPU 32 acquires the first and second counted values that have respectively been counted by the first and second frequency counters 24 and 25.

The CPU 32 further acquires information about the characteristics of the first and second resonant pressure sensors 22 and 23 from the first and second memories 26 and 27. The CPU 32 sends the second communication processor 42 first and second parallel signals of instructions so that the CPU 32 acquires first and second sets of information about the characteristics of the first and second resonant pressure sensors 22 and 23, respectively. The first and second parallel signals of instructions are to acquire the characteristics of the first and second resonant pressure sensors 22 and 23, respectively. The second communication processor 42 converts the first and second parallel signals of instructions into a serial signal of instructions. The serial signal of instructions is transmitted from the second communication processor 42 through the cable 43 to the first communication processor 43.

The first communication processor 41 receives the serial signal of instructions from the CPU 32. The first communication processor 41 acquires, from the first and second memories 26 and 27, first and second parallel signals that include the first and second sets of information about the characteristics of the first and second resonant pressure sensors 22 and 23, respectively. The first communication processor 41 converts the first and second parallel signals into a serial signal. The serial signal includes the first and second sets of information, because the first and second parallel signals include the first and second sets of information, respectively. The serial signal is transmitted from the first communication processor 41 to the second communication processor 42 through the cable 43. The second communication processor 42 converts the serial signal into first and second parallel signals that include the first and second sets of information about the characteristics of the first and second resonant pressure sensors 22 and 23, respectively. The first and second parallel signals are transmitted from the first communication processor 41 to the CPU 32. The CPU 32 acquires the first and second sets of information about the characteristics of the first and second resonant pressure sensors 22 and 23.

Accordingly, the CPU acquires the first and second counted values and the first and second sets of information about the characteristics of the first and second resonant pressure sensors 22 and 23.

The CPU 32 calculates first and second pressure values as the first and second pressures of a fluid, wherein the calculation is made based on the first and second counted values that have been counted by the first and second frequency counters 24 and 25. As described above, the first and second pressures of a fluid travel from the upstream and downstream portions of the pipe 100 through the first and second impulse lines 110 and 120, respectively.

Further, the CPU 32 calculates first and second correction factors based on the first and second sets of information about the characteristics of the first and second resonant pressure sensors 22 and 23, respectively. The CPU 32 applies the first and second correction factors to the first and second calculated pressure values, thereby obtaining first and second corrected pressure values.

Furthermore, the CPU 32 calculates a differential pressure value which is the difference between the first and second corrected pressure values. The calculated differential pressure is estimated as the actual differential pressure between the first and second pressures of a fluid that travel from the upstream and downstream portions of the pipe 100 through the first and second impulse lines 110 and 120. The CPU 32 generates a differential pressure signal that indicates the calculated differential pressure value.

The differential pressure signal is transmitted from the CPU 32 to both the display 33 and the converter 34. The display 33 displays the calculated differential pressure on the screen 331. The converter 34 converts the differential pressure signal into a converted signal that is adaptable to the external device. The converted signal is transmitted from the converter 34 through the wiring 5 to the external device.

In some cases, the external device may be configured to store additional information about the density of a fluid that flows through the pipe 100. The pressure measuring apparatus 1 may be configured to allow the external device to calculate the flow rate of the fluid flowing through the pipe 100, based on the calculated differential pressure and the density of the fluid that has previously been stored in the external device.

The first and second counted values that have been counted by the first and second frequency counters 24 and 25 included in the sensor unit 2 are transmitted as digital signals to the CPU 32 included in the processing unit 3. The transmission of the digital signals is effective to allow the transmitted signals to be free of any noises. In other words, the transmission of the digital signals allows that the results of detection by the first and second resonant pressure sensors 22 and 23 are securely transmitted to the CPU 32.

The sensor unit 2 and the processing unit 3 are configured to be separate from each other and be functionally or electrically coupled to each other through the cable 43. The sensor unit 2 does not need to be maintained. The processing unit 3 needs to be maintained. Thus, the sensor unit 2 may be placed near the pipe 100, while the processing unit 3 is placed in view of operability and visibility.

The above-described configuration of the pressure measuring apparatus 1 can improve the operability and the visibility while maintaining high reliance.

The above-described configuration of the pressure measuring apparatus 1 allows the sensor unit 2 to be placed near the pipe 100, thereby allowing the first and second impulse lines 110 and 120 to have short lengths. Shortening the lengths of the first and second impulse lines 110 and 120 can reduce the manufacturing cost thereof.

The first and second communication processors 41 and 42 communicate with each other by serial signals. Thus, the first and second communication processors 41 and 42 are connected through the single cable 43. It is possible as a modification that the first and second communication processors 41 and 42 be configured to communicate with each other by parallel signals, provided that the first and second communication processors 41 and 42 are coupled to each other through plural cables.

### Second Embodiment

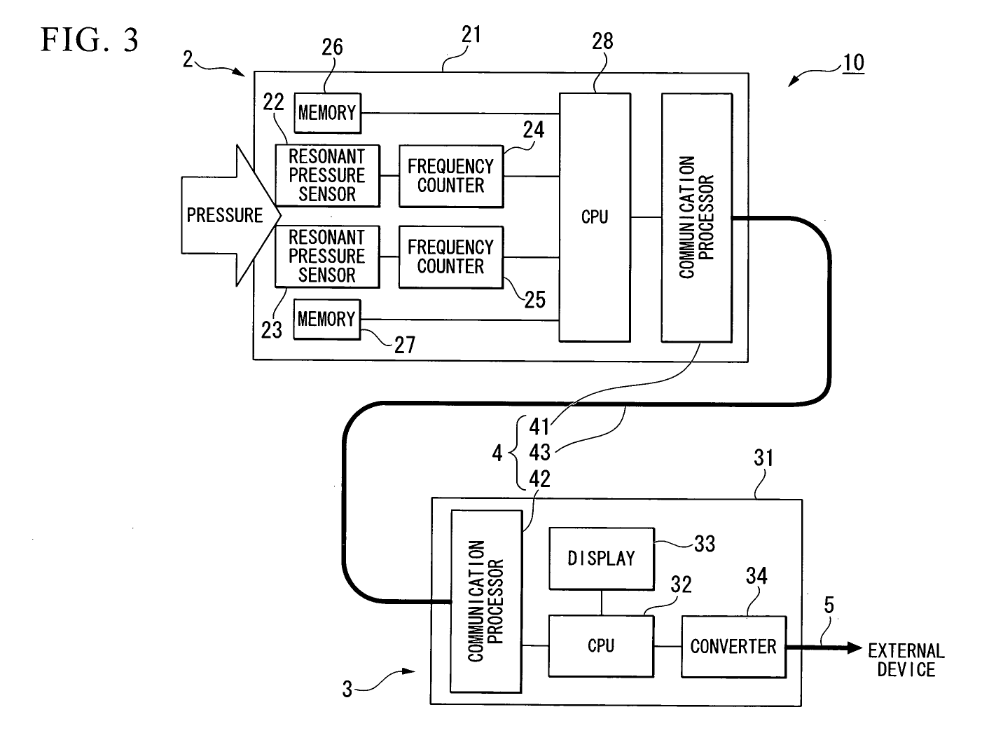

FIG. 3 is a block diagram illustrating the functional configurations of a modified pressure measuring apparatus in accordance with a second embodiment of the present invention. A pressure measuring apparatus 10 is different from the above-described pressure measuring apparatus 1 in the configuration of the sensor unit 2. The following descriptions will be directed to the difference in the configuration between the pressure measuring apparatus 10 and the above-described pressure measuring apparatus 1.

The sensor unit 2 may further include an auxiliary CPU 28. Namely, the sensor unit 2 may include, but is not limited to, the auxiliary CPU 28, the first enclosure 21, the first and second resonant pressure sensors 22 and 23, the first and second frequency counters 24 and 25, and the first and second memories 26 and 27. The auxiliary CPU 28 may be functionally or electrically coupled to the first and second frequency counters 24 and 25, and the first and second memories 26 and 27. The auxiliary CPU 28 is also functionally or electrically coupled to the first communication processor 41. The auxiliary CPU 28 may be enclosed in the first enclosure 21.

The auxiliary CPU 28 may be configured to acquire the first and second counted values from the first and second frequency counters 24 and 25. Also, the auxiliary CPU 28 may be configured to acquire the first and second sets of information about the characteristics of the first and second resonant pressure sensors 22 and 23, wherein the first and second sets of information are stored in the first and second memories 26 and 27, respectively.

The auxiliary CPU 28 calculates, based on the first and second counted values, the first and second pressures of a fluid that have traveled through the first and second impulse lines 110 and 120 to the first and second resonant pressure sensors 22 and 23, respectively. The auxiliary CPU 28 corrects the calculated values of the first and second pressures of a fluid with reference to the first and second sets of information about the characteristics of the first and second resonant pressure sensors 22 and 23. The auxiliary CPU 28 calculates the difference between the corrected values of the first and second pressures of a fluid, thereby calculating a differential pressure between the first and second pressures of a fluid that have traveled through the first and second impulse lines 110 and 120 to the first and second resonant pressure sensors 22 and 23.

The auxiliary CPU 28 generates parallel signals that indicate the calculated differential pressure. The auxiliary CPU 28 transmits the parallel signals to the first communication processor 41. The first communication processor 41 receives the parallel signals from the auxiliary CPU 28 and converts the parallel signals into a serial signal. The serial signal is transmitted from the first communication processor 41 through the cable 43 to the second communication processor 42. The second communication processor 42 converts the serial signal into parallel signals. The parallel signals are then transmitted from the second communication processor 42 to the CPU 32. The parallel signals indicate the differential pressure. The CPU 32 scales the parallel signals. The CPU 32 also transmits the parallel signals to the display 33 and the converter 34.

As described above, the pressure measuring apparatus 10 may be configured to provide the auxiliary CPU 28 in the sensor unit 2 in addition to the CPU 32 in the processor unit 3. The pressure measuring apparatus 10 assigns, to the auxiliary CPU 28 in the senor unit 2, a part of the functions of the CPU 32 in the processor unit 3. The auxiliary CPU 28 reduces the load of the CPU 32 in the processor unit 3.

### Third Embodiment

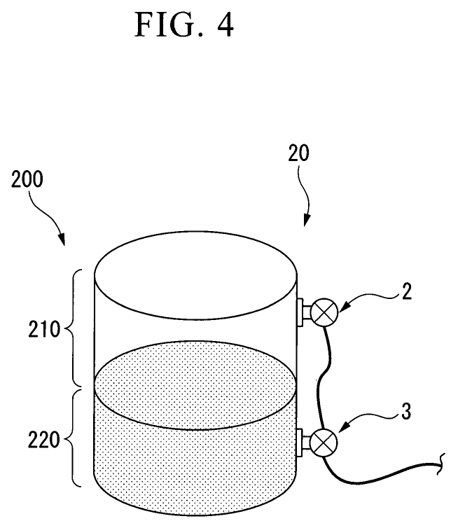

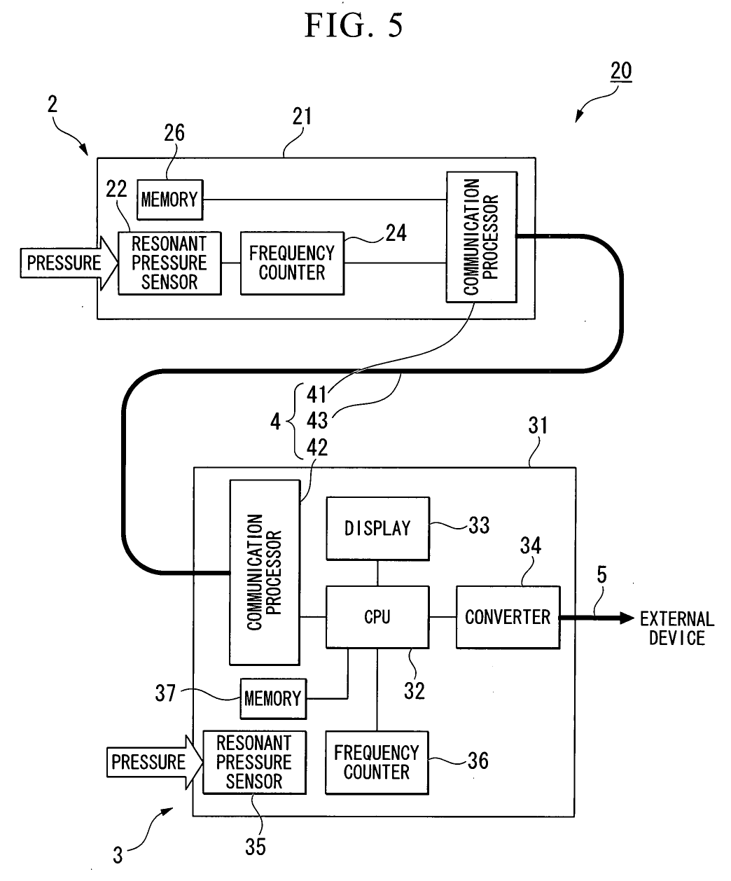

FIG. 4 is a schematic perspective view illustrating a pressure measuring apparatus in accordance with a third embodiment of the present invention. FIG. 5 is a block diagram illustrating the functional configurations of the pressure measuring apparatus shown in FIG. 4.

A pressure measuring apparatus 20 is provided to a closed tank 200. The closed tank 200 is configured to reserve a fluid. The closed tank 200 includes upper and lower portions 210 and 220 thereof. The pressure measuring apparatus 20 may include the sensor unit 2, the processing unit 3 and the communication unit 4. The sensor unit 2 is provided to the upper portion 210 of the closed tank 200, while the processor unit 3 is provided to the lower portion 220 of the closed tank 200. The upper portion 210 of the closed tank 200 provides poor operability and visibility to the sensor unit 2, while the lower portion 210 of the closed tank 200 provides rich operability and visibility to the processing unit 3. The sensor unit 2 and the processing unit 3 may be functionally or electrically coupled to each other through the same cable as the cable 43 described with reference to FIGS. 1-3.

As shown in FIG. 5, the sensor unit 2 may include, but is not limited to, the first enclosure 21, the first resonant pressure sensor 22, the first frequency counter, and the first memory 26. The first resonant pressure sensor 22 may be placed adjacent to the upper portion 210 of the closed tank 200. The first resonant pressure sensor 22 may be coupled directly to the upper portion 210 of the closed tank 200. The first enclosure 21 may be configured to enclose the first resonant pressure sensor 22, the first frequency counter 24, the first memory 26, and the first communication processor 41.

The lower portion 220 is configured to reserve a fluid. The upper and lower portions 210 and 220 of the closed tank 200 have first and second internal pressures, respectively. The first resonant pressure sensor 22 may be configured to receive and detect the first internal pressure of the upper portion 210 of the closed tank 200. The first resonant pressure sensor 22 may be configured to generate a first analog signal that has a first frequency that depends on the first internal pressure.

The first frequency counter 24 may be configured to be electrically connected to the first resonant pressure sensor 22 so as to receive the first analog signal with the first frequency from the first resonant pressure sensor 22. The first frequency counter 24 may be configured to count the first frequency of the first analog signal. The first frequency counter 24 may be configured to generate a first parallel signal as a digital signal that indicates a first counted value that corresponds to the first frequency. The first frequency counter 24 may be configured to output the first parallel signal that includes the first counted value.

The first memory 26 may be configured to store the characteristics of the first resonant pressure sensor 22. The communication unit 4 may include the first and second communication processors 41 and 42, and the cable 43 that connects the first and second communication processors 41 and 42 to each other.

The first communication processor 41 may be contained in the first enclosure 21 of the sensor unit 2. The first communication processor 41 may be electrically connected to the first memory 26 and the first frequency counter 24. The first communication processor 41 may be configured to receive the characteristics of the first resonant pressure sensor 22 from the first memory 26. The first communication processor 41 may be configured to receive the first parallel signal from the first frequency counter 24. The first communication processor 41 may be configured to convert the first parallel signal into a serial signal that includes the characteristics of the first resonant pressure sensor 22 and the first counted value. The converted serial signal includes the characteristics of the first resonant pressure sensor 22 and the first counted value. The first counted value indicates the first frequency that further indicates the first internal pressure. The converted serial signal is transmitted from the first communication processor 41 through the cable 43 to the second communication processor 42. The second communication processor 42 may be configured to convert the serial signal into a first parallel signal. The first parallel signal includes the characteristics of the first resonant pressure sensor 22 and the first counted value.

The processing unit 3 may be configured to be separate from the sensor unit 2. The processing unit 3 may be configured to be spatially separate from the sensor unit 2 but to be functionally coupled to the sensor unit 2. The processing unit 3 may include, but is not limited to, a second enclosure 31, a CPU 32, a display 33, a converter 34, a second memory 37, a second resonant pressure sensor 35, and a second frequency counter 36. The second enclosure 31 may be configured to enclose the CPU 32, the display 33, the converter 34, the second memory 37, the second resonant pressure sensor 35, and the second frequency counter 36 as well as the second communication processor 42.

The second resonant pressure sensor 35 may be configured to receive and detect the second internal pressure of the lower portion 220 of the closed tank 200. The second resonant pressure sensor 35 may be configured to generate a second analog signal that has a second frequency that depends on the second internal pressure.

The second frequency counter 36 may be configured to be electrically connected to the second resonant pressure sensor 35 so as to receive the second analog signal with the second frequency from the second resonant pressure sensor 35. The second frequency counter 36 may be configured to count the second frequency of the second analog signal. The second frequency counter 36 may be configured to generate a second parallel signal as a digital signal that indicates a second counted value that corresponds to the second frequency. The second frequency counter 36 may be configured to output the second parallel signal that includes the second counted value. The second memory 26 may be configured to store the characteristics of the second resonant pressure sensor 35.

The CPU 32 may be electrically or functionally coupled to the second communication processor 42 to receive the first parallel signal from the second communication processor 42. The converted parallel signal includes the characteristics of the first resonant pressure sensor 22 and the first counted value. The CPU 32 may be electrically or functionally coupled to the second memory 37 to receive the characteristics of the second resonant pressure sensor 35. The CPU 32 may be electrically or functionally coupled to the second frequency counter 36 to receive the second parallel signal that includes the second counted value. As a result, the CPU 32 acquires the first and second counted values that have respectively been counted by the first and second frequency counters 24 and 36. The CPU 32 further acquires information about the characteristics of the first and second resonant pressure sensors 22 and 35.

The CPU 32 calculates first and second internal pressure values as the first and second pressures of a fluid, wherein the calculation is made based on the first and second counted values that have been counted by the first and second frequency counters 24 and 25.

Further, the CPU 32 calculates first and second correction factors based on the first and second sets of information about the characteristics of the first and second resonant pressure sensors 22 and 35, respectively. The CPU 32 applies the first and second correction factors to the first and second calculated internal pressure values, thereby obtaining first and second corrected internal pressure values.

Furthermore, the CPU 32 calculates a differential pressure value which is the difference between the first and second corrected internal pressure values. The calculated differential pressure is estimated as the actual differential pressure between the first and second internal pressures of the upper and lower parts 210 and 220 of the closed tank 200. The CPU 32 generates a differential pressure signal that indicates the calculated differential pressure value.

The differential pressure signal is transmitted from the CPU 32 to both the display 33 and the converter 34. The display 33 displays the calculated differential pressure on the screen 331. The converter 34 converts the differential pressure signal into a converted signal that is adaptable to the external device. The converted signal is transmitted from the converter 34 through the wiring 5 to the external device.

In accordance with this embodiment, the second resonant pressure sensor 35 may be provided in the processor unit 3 if the processor unit 3 is placed in view of operability and visibility.

In some cases, the external device may be configured to store additional information about the density of a fluid that is reserved in the closed tank 200. The pressure measuring apparatus 1 may be configured to allow the external device to calculate the amount and the level of a fluid in the closed tank 200, based on the calculated differential pressure and the density of the fluid that has previously been stored in the external device.

As described above, the measuring apparatus of the present invention is applied to the pressure measuring apparatus. However, the measuring apparatus of the present invention is applicable to any type of measuring apparatus such as temperature measuring apparatuses and light quantity measuring apparatuses. The above-described pressure sensors can be replaced by other sensors that are configured to measure a target physical quantity.

As described above, the electrical digital signal that includes the pressure value is transmitted from the resonant pressure sensor to the CPU 32. It is also possible as a modification that an optical signal that includes the pressure value is transmitted from the resonant pressure sensor to the CPU 32. If the optical signal is used instead of the electrical signal, then the present invention can reduce the noise included in the optical signal.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A measuring apparatus comprising:
a sensor unit that comprises at least one sensor, the at least one senor being configured to generate an output signal;
a processing unit configured to be separate from the sensor unit, the processing unit being configured to perform at least a first set of operations based on the output signal; and
a communication unit coupling the sensor unit and the processing unit, the communication unit being configured to transmit the output signal as a digital signal from the sensor unit to the processing unit.

2. The measuring apparatus according to claim 1, wherein the processing unit comprises:
a processor configured to perform the operation based on the output signal and generate a first set of information; and
a display that is configured to receive the first set of information from the processor and display the first set of information.

3. The measuring apparatus according to claim 1, wherein the sensor unit comprises at least a storage unit configured to store the characteristics of the at least a sensor, and
the communication unit is configured to transmit the characteristics of the at least a sensor to the processing unit.

4. The measuring apparatus according to claim 1, wherein the sensor unit comprises an auxiliary processor configured to perform a second set of operations.

5. The measuring apparatus according to claim 1, wherein the processor is configured to perform a second set of operations in addition to the first set of operations.

6. The measuring apparatus according to claim 1, wherein the communication unit comprises:
a first communication processor functionally coupled to the sensor unit;
a second communication processor functionally coupled to the processor unit; and
a communication cable that connects the first and second communication processors to each other.

7. The measuring apparatus according to claim 6, wherein the first communication processor and the sensor unit are enclosed in a first enclosure, and
the second communication processor and the processor unit are enclosed in a second enclosure.

8. The measuring apparatus according to claim 1, wherein the communication unit is configured to transmit the output signal as a serial digital signal.

9. The measuring apparatus according to claim 1, wherein the processing unit comprises at least an additional sensor.
